(19) United States
(12) Patent Application Publication
(10) Pub. No.: US 2013/0168325 A1
(43) Pub. Date: Jul. 4, 2013

(54) APPARATUS FOR PHOSPHOROUS REMOVAL FROM WASTE WATER

(71) Applicants: Kyung Guen Song, Seoul (KR); Seok Won Hong, Seoul (KR); Byung Ha Lee, Seoul (KR); Ho Young Cha, Seoul (KR)

(72) Inventors: Kyung Guen Song, Seoul (KR); Seok Won Hong, Seoul (KR); Byung Ha Lee, Seoul (KR); Ho Young Cha, Seoul (KR)

(21) Appl. No.: 13/680,703

(22) Filed: Nov. 19, 2012

(30) Foreign Application Priority Data
Dec. 30, 2011 (KR) 10-2011-0147027

(51) Int. Cl. C02F 1/52

(52) U.S. Cl. CPC C02F 1/5236; C02F 1/5281; C02F 1/5227
USPC 210/726; 210/202

(57) ABSTRACT

Provided are an apparatus for removing phosphorous from wastewater including: a first coagulation sedimentation unit including a first rapid mixing tank, a first flocculation tank and a first sedimentation tank; and a second coagulation sedimentation unit including a second rapid mixing tank, a second flocculation tank and a second sedimentation tank, and a method for removing phosphorous using the same. The first rapid mixing tank stirs wastewater and an inorganic coagulant with low basicity at high speed and the second rapid mixing tank stirs the treated water supplied from the first sedimentation tank and an inorganic coagulant with high basicity at high speed. As a result, removal of phosphorous from the wastewater is maximized and coagulation and sedimentation may be optimized through control of metal content in the inorganic coagulants added to the first rapid mixing tank and the second rapid mixing tank.

### CROSS-REFERENCE TO RELATED APPLICATIONS

This application claims priority to Korean Patent Application No. 10-2011-0147027, filed on Dec. 30, 2011, and all the benefits accruing therefrom under 35 U.S.C. §119, the contents of which in its entirety are herein incorporated by reference.

### BACKGROUND

1. Field

The present disclosure relates to an apparatus for removing phosphorous from wastewater and a method for removing phosphorous using the same. More particularly, the disclosure relates to an apparatus for removing phosphorous from wastewater having two coagulation sedimentation units and capable of effectively removing phosphorous included in wastewater by adding different coagulants to the respective coagulation sedimentation units according to the properties of the wastewater, and a method for removing phosphorous.

2. Description of the Related Art

Phosphorous (P) is one of the causes of eutrophication along with nitrogen (N) and removal of phosphorous is an important issue in management of water quality. Korea is implementing the double total maximum load system of controlling total phosphorus (TP) to prevent eutrophication in the lower parts of rivers since 2011.

Although the TP standard for the water released from the wastewater treatment facilities in Korea was strengthened on Jan. 1, 2008 (2 mg/L in summer, 8 mg/L in winter), even stricter standard (0.2 mg/L) is applied from 2012. Since the current control of TP based on biological treatment reveals limitations, various chemical treatment techniques are necessary to meet the new TP standard.

Hence, chemical treatment is drawing more attentions recently than biological treatment. The chemical treatment techniques of treating phosphorus include coagulation, precipitation as magnesium ammonium phosphate (MAP), and so forth. Recently, membrane bioreactor (MBR)-based techniques are also gaining a lot of attentions. However, it is difficult to meet the water quality standard with coagulation only and the membrane-based techniques are economically unfavorable due to high initial investment cost and maintenance cost. An example of the coagulation technique is described in Korean Patent Registration No. 957502.

### SUMMARY

The present disclosure is directed to providing an apparatus for removing phosphorous from wastewater having two coagulation sedimentation units and capable of effectively removing phosphorous included in wastewater by adding different coagulants to the respective coagulation sedimentation units according to the properties of the wastewater, and a method for removing phosphorous.

In one aspect, there is provided an apparatus for removing phosphorous from wastewater including: a first coagulation sedimentation unit including a first rapid mixing tank, a first flocculation tank and a first sedimentation tank; and a second coagulation sedimentation unit including a second rapid mixing tank, a second flocculation tank and a second sedimentation tank, wherein the first rapid mixing tank stirs wastewater and an inorganic coagulant with low basicity at high speed so as to generate flocs by reacting phosphide anions included in the wastewater directly with metal cations included in the inorganic coagulant with low basicity, and the second rapid mixing tank stirs the treated water supplied from the first sedimentation tank and an inorganic coagulant with high basicity at high speed so as to generate hydroxide salts by reacting the flocs included in the treated water with the inorganic coagulant with high basicity, the inorganic coagulant with low basicity having a relatively lower basicity than that of the inorganic coagulant added to the second rapid mixing tank, and the inorganic coagulant with high basicity having a relatively higher basicity than that of the inorganic coagulant added to the first rapid mixing tank.

The inorganic coagulant with low basicity and the inorganic coagulant with high basicity may be respectively added to the first rapid mixing tank and the second rapid mixing tank such that the metal content of the inorganic coagulant with low basicity is the same as the metal content of the inorganic coagulant with high basicity. Aluminum sulfate and polyaluminum chloride may be used respectively as the inorganic coagulant with low basicity and the inorganic coagulant with high basicity such that the aluminum (Al) content of the two is identical.

The amount of the inorganic coagulants added respectively to the first rapid mixing tank and the second rapid mixing tank may be 0.1-15 wt % based on the total phosphorus (TP) included in the wastewater in the respective rapid mixing tanks.

The inorganic coagulant with low basicity may be one of aluminum sulfate, ferric sulfate, aluminum chloride, ferric chloride, ferric aluminum sulfate and magnesium chloride, and the inorganic coagulant with high basicity may be one of polyaluminum chloride, polyaluminum chloride silicate, polyaluminum hydroxychlorosulfate, polyaluminum chloride sulfate silicate and polyaluminum sulfate silicate.

In another aspect, there is provided a method for removing phosphorous using an apparatus including a first coagulation sedimentation unit including a first rapid mixing tank, a first flocculation tank and a first sedimentation tank and a second coagulation sedimentation unit including a second rapid mixing tank, a second flocculation tank and a second sedimentation tank, including: the first rapid mixing tank stirring wastewater and an inorganic coagulant with low basicity at high speed so as to generate flocs by reacting phosphide anions included in the wastewater directly with metal cations included in the inorganic coagulant with low basicity; and the second rapid mixing tank stirring the treated water supplied from the first sedimentation tank and an inorganic coagulant with high basicity at high speed so as to generate hydroxide salts by reacting the flocs included in the treated water with the inorganic coagulant with high basicity, wherein the inorganic coagulant with low basicity has a relatively lower basicity than that of the inorganic coagulant added to the second rapid mixing tank, and the inorganic coagulant with high basicity has a relatively higher basicity than that of the inorganic coagulant added to the first rapid mixing tank.

The apparatus for removing phosphorous from wastewater and the method for removing phosphorous using the same according to the present disclosure provide the following advantageous effects.

By using the two coagulation sedimentation units, wherein the inorganic coagulant of relatively low basicity is added to the first coagulation sedimentation unit to induce direct reaction with phosphide anions and the inorganic coagulant of relatively high basicity is added to the second coagulation sedimentation unit to induce removal of fine flocs, removal of phosphorous from the wastewater may be maximized.

In addition, coagulation and sedimentation may be optimized through control of metal content in the inorganic coagulants added to the first rapid mixing tank and the second rapid mixing tank.

### BRIEF DESCRIPTION OF THE DRAWING

The above and other aspects, features and advantages of the disclosed exemplary embodiments will be more apparent from the following detailed description taken in conjunction with the accompanying drawing in which:

FIG. 1 shows the configuration of an apparatus for removing phosphorous from wastewater according to an exemplary embodiment of the present disclosure.

### DETAILED DESCRIPTION

In the present disclosure, two coagulation sedimentation units, i.e. a first coagulation sedimentation unit and a second coagulation sedimentation unit, are provided. An inorganic coagulant with low basicity is added to the first coagulation sedimentation unit wherein the wastewater contained therein has a relatively higher phosphorus content than that in the second coagulation sedimentation unit, and an inorganic coagulant with high basicity is added to the second coagulation sedimentation unit wherein the wastewater contained therein has a relatively lower phosphorus content than that in the first coagulation sedimentation unit. The first coagulation sedimentation unit induces direct reaction between phosphide anions and metal cations included in the inorganic coagulant, and the second coagulation sedimentation unit induces hydroxylation reaction between flocs, floating matters and the inorganic coagulant.

Hereinafter, an apparatus for removing phosphorous from wastewater and a method for removing phosphorous using the same according to an exemplary embodiment of the present disclosure will be described in detail with reference to the accompanying drawings.

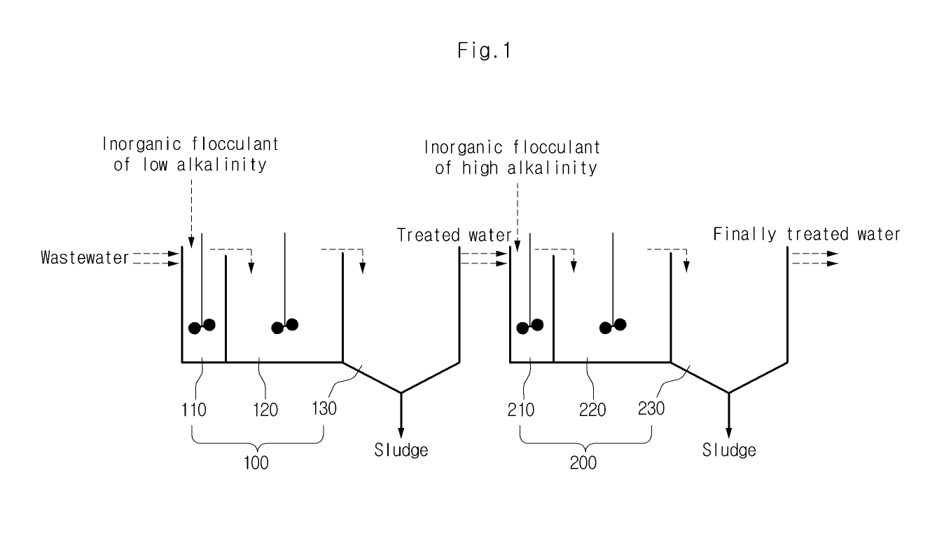

Referring to FIG. 1, an apparatus for removing phosphorous from wastewater according to an exemplary embodiment of the present disclosure comprises a first coagulation sedimentation unit 100 and a second coagulation sedimentation unit 200.

The first coagulation sedimentation unit 100 comprises a first rapid mixing tank 110, a first flocculation tank 120 and a a first sedimentation tank 130, and the second coagulation sedimentation unit 200 comprises a second rapid mixing tank 210, a second flocculation tank 220 and a second sedimentation tank 230.

The first rapid mixing tank 110 stirs wastewater and an inorganic coagulant with low basicity at high speed so as to generate flocs by reacting phosphide anions included in the wastewater directly with metal cations included in the inorganic coagulant with low basicity. The “low basicity” of the inorganic coagulant with low basicity is a relative concept as compared to the basicity of an inorganic coagulant added to the second rapid mixing tank 210. The coagulant added to the first rapid mixing tank 110 has a relatively lower basicity than that of the inorganic coagulant added to the second rapid mixing tank 210.

The reason why the inorganic coagulant with low basicity having a relatively lower basicity is added to the first rapid mixing tank 110 is because the inorganic coagulant with low basicity has higher reactivity. As a result, direct reaction between the metal cations of the inorganic coagulant with low basicity and phosphide anions included in the wastewater may be induced and the content of the phosphide anions in the wastewater may be decreased through the direct reaction using the inorganic coagulant with low basicity. The inorganic coagulant with low basicity may be one of aluminum sulfate, ferric sulfate, aluminum chloride, ferric chloride, ferric aluminum sulfate and magnesium chloride.

The first flocculation tank 120 serves to receive the flocs and the wastewater from the first rapid mixing tank 110 and increase the size and sedimentability of the flocs by stirring at low speed. The first sedimentation tank 130 serves to receive the flocs and the wastewater from the first flocculation tank 120 and separates them into treated water and sludge by gravitational sedimentation. The treated water separated by the first sedimentation tank 130 is supplied to the second rapid mixing tank 210 of the second coagulation sedimentation unit 200.

The second rapid mixing tank 210 serves to stir the treated water supplied from the first sedimentation tank 130 and the inorganic coagulant with high basicity at high speed so as to generate hydroxide salts by reacting the flocs included in the treated water with the inorganic coagulant with high basicity. Since the treated water discharged from the first sedimentation tank 130 has a small phosphorus content and contains fine flocs, a coagulant is necessary to remove the fine flocs. The inorganic coagulant with high basicity serves to induce the formation of hydroxide salts by enhancing the crosslinking of the fine flocs.

Whereas the first rapid mixing tank 110 induces direct removal of phosphorus through direct reaction between phosphide anions and metal cations using the inorganic coagulant with low basicity, the second rapid mixing tank 210 induces generation of hydroxide salts from the fine flocs using the inorganic coagulant with high basicity. The inorganic coagulant with high basicity added to the second rapid mixing tank 210 has a relatively higher basicity than the inorganic coagulant added to the first rapid mixing tank 110. The inorganic coagulant with high basicity may be one of polyaluminum chloride, polyaluminum chloride silicate, polyaluminum hydroxychlorosulfate, polyaluminum chloride sulfate silicate and polyaluminum sulfate silicate.

The second flocculation tank 220 serves to increase the size of the hydroxide salts by stirring the flocs in the form of the hydroxide salts and the treated water supplied from the second rapid mixing tank 210, and the second sedimentation tank 230 serves to receive the hydroxide salts and the treated water from the second flocculation tank 220 and separate them into finally treated water and sludge by gravitational sedimentation.

The amount of the inorganic coagulant with low basicity and the inorganic coagulant with high basicity added respectively to the first rapid mixing tank 110 and the second rapid mixing tank 210 may be 0.1-15 wt % based on the total phosphorus (TP) included in the wastewater in the respective rapid mixing tanks. If the addition amount of the inorganic coagulant exceeds 15 wt %, a problem may occur.

The efficiency of coagulation and sedimentation is highest when the inorganic coagulant with low basicity and the inorganic coagulant with high basicity are respectively added to the first rapid mixing tank 110 and the second rapid mixing tank 210 such that the metal content of the inorganic coagulant with low basicity is identical to the metal content of the inorganic coagulant with high basicity. In particular, when aluminum sulfate and polyaluminum chloride are used respectively as the inorganic coagulant with low basicity and the inorganic coagulant with high basicity, the efficiency of coagulation and sedimentation is highest when the content of aluminum (Al) is identical. This is corroborated by the examples described below.

An apparatus for removing phosphorous from wastewater and a method for removing phosphorous using the same according to an exemplary embodiment of the present disclosure was described in detail above. Hereinafter, the present disclosure will be described in further detail through test examples.

### Test Example 1

Through repeated experiments, it was found out that both the first coagulation sedimentation unit and the second coagulation sedimentation unit result in optimal efficiency when high-speed stirring is performed at 250 rpm for 1 minute, low-speed stirring is performed at 60 rpm for 15 minutes and sedimentation is performed for 30 minutes. Therefore, all experiments were carried out under the condition of above-described stirring speed and time. Total phosphorus (TP), dissolved phosphorus and suspended solids (SS) were analyzed.

### Test Example 2

Two-stage coagulation was performed using aluminum sulfate containing 8% Al₂O₃. Table 1 compares the result of carrying out two-stage coagulation by adding 1.5 mg Al/L of aluminum sulfate to the first rapid mixing tank and adding 1.5 mg Al/L of aluminum sulfate to the second rapid mixing tank with that of carrying out one-stage coagulation by adding 3 mg Al/L of aluminum sulfate. The two-stage coagulation refers to a coagulation process using the two coagulation sedimentation units according to the present disclosure, and the one-stage coagulation refers to a coagulation process using a coagulation sedimentation unit comprising a rapid mixing tank, a flocculation tank and a sedimentation tank.

TABLE 1
Total addition amount of aluminum sulfate = 3 mg Al/L

| | TP | | |
|---|---|---|---|
| | (mg/L) | PO₄³⁻ (mg/L) | SS (mg/L) |
| Wastewater | 0.73 | 0.49 | 9.6 |
| First-stage coagulation | 0.21 | 0.17 | 4.8 |
| Second-stage coagulation | 0.09 | 0.07 | 3.2 |
| according to the present disclosure | | | |

As seen from Table 1, the wastewater from a wastewater treatment facility had a TP of 0.73 mg/L, PO₄³⁻ of 0.49 mg/L and SS of 9.6 mg/L. When the total addition amount of aluminum sulfate was 3 mg Al/L, it was difficult to meet the new water quality standard with the one-stage coagulation process. In contrast, the two-stage coagulation process according to the present disclosure stably satisfies the new water quality standard, with a very low TP of 0.09 mg/L.

### Test Example 3

Two-stage coagulation was performed using polyaluminum chloride containing 17% Al₂O₃. Table 2 compares the result of carrying out two-stage coagulation by adding 1.5 mg Al/L of polyaluminum chloride to the first rapid mixing tank and adding 1.5 mg Al/L of polyaluminum chloride to the second rapid mixing tank with that of carrying out one-stage coagulation by adding 3 mg Al/L of polyaluminum chloride.

TABLE 2
Total addition amount of polyaluminum chloride = 3 mg Al/L

| | TP | | |
|---|---|---|---|
| | (mg/L) | PO₄³⁻ (mg/L) | SS (mg/L) |
| Wastewater | 0.73 | 0.49 | 9.6 |
| First-stage coagulation | 0.19 | 0.14 | 3.9 |
| Second-stage coagulation | 0.08 | 0.02 | 3.0 |
| according to the present disclosure | | | |

As seen from Table 2, when the total addition amount of polyaluminum chloride was 3 mg Al/L, the TP and PO₄³⁻ of the one-stage coagulation process were 0.19 mg/L and 0.14 mg/L, respectively, which are difficult to stably meet the new water quality standard. In contrast, the two-stage coagulation process according to the present disclosure stably satisfies the new water quality standard, with a very low TP of 0.08 mg/L. In addition, the two-stage coagulation process according to the present disclosure shows a distinct difference in the removal efficiency of PO₄³⁻ from the one-stage coagulation process.

### Test Example 4

Two-stage coagulation was performed using aluminum sulfate containing 8% Al₂O₃ and polyaluminum chloride containing 17% Al₂O₃. 4 mg Al/L of aluminum sulfate was added to the first rapid mixing tank and 1 mg Al/L of polyaluminum chloride was added to the second rapid mixing tank.

### Test Example 5

Two-stage coagulation was performed using aluminum sulfate containing 8% Al₂O₃ and polyaluminum chloride containing 17% Al₂O₃. 2.5 mg Al/L of aluminum sulfate was added to the first rapid mixing tank and 2.5 mg Al/L of polyaluminum chloride was added to the second rapid mixing tank.

### Test Example 6

Two-stage coagulation was performed using aluminum sulfate containing 8% Al₂O₃ and polyaluminum chloride containing 17% Al₂O₃. 1 mg Al/L of aluminum sulfate was added to the first rapid mixing tank and 4 mg Al/L of polyaluminum chloride was added to the second rapid mixing tank.

### Test Example 7

For comparison with Test Example 4, Test Example 5 and Test Example 6, one-stage coagulation was performed using 5 mg Al/L of aluminum sulfate containing 8% Al₂O₃ and using 5 mg Al/L of polyaluminum chloride containing 17% Al₂O₃. Tables 3 and 4 compares the result of Test Examples 4-7.

TABLE 3

| | TP | | |
|---|---|---|---|
| | (mg/L) | PO₄³⁻ (mg/L) | SS (mg/L) |
| Wastewater | 3.0 | 2.3 | 15.6 |
| First-stage coagulation using 5 mg | 0.46 | 0.18 | 5.2 |
| Al/L of aluminum sulfate | | | |
| First-stage coagulation using 5 mg | 0.35 | 0.16 | 4.9 |
| Al/L of polyaluminum chloride | | | |

TABLE 4
Aluminum sulfate added to first rapid mixing tank & polyaluminum
chloride added to second rapid mixing tank

| | TP (mg/L) | PO₄³⁻ (mg/L) | SS (mg/L) |
|---|---|---|---|
| Wastewater | 3.0 | 2.3 | 15.6 |
| 4 mg Al/L + 1 mg Al/L | 0.21 | 0.15 | 3.4 |
| 2.5 mg Al/L + 2.5 mg Al/L | 0.13 | 0.08 | 1.2 |
| 1 mg Al/L + 4 mg Al/L | 0.19 | 0.16 | 3.2 |

One-stage coagulation was performed using aluminum sulfate resulted in 0.46 mg/L of TP, 0.38 mg/L of PO₄³⁻ and 5.2 mg/L of SS. And, one-stage coagulation was performed using polyaluminum chloride resulted in 0.35 mg/L of TP, 0.31 mg/L of PO₄³⁻ and 4.9 mg/L of SS. The wastewater contained 3 mg P/L of TP, 2.3 mg P/L of PO₄³⁻ and 15.6 mg/L of SS.

As seen from Table 3, when only one coagulant was used, the water quality standard for discharged water (TP: 0.2 mg/L) could not be satisfied. When one-stage coagulation was performed using aluminum sulfate, the dissolved phosphorus was removed well through coagulation but the SS were not removed well since the growth of flocs was insufficient. And, when one-stage coagulation was performed using polyaluminum chloride, sedimentation occurred better than when aluminum sulfate was used but the growth of flocs was rather slow. Two-stage coagulation resulted in more effective removal than one-stage coagulation given the same addition amount.

Two-stage coagulation performed with 4 mg Al/L of aluminum sulfate and then with 1 mg/L of polyaluminum chloride resulted in 0.21 mg/L of TP, 0.15 mg/L of PO₄³⁻ and 3.4 mg/L of SS. Two-stage coagulation performed with 2.5 mg Al/L of aluminum sulfate and then with 2.5 mg/L of polyaluminum chloride resulted in 0.13 mg/L of TP 0.08 mg/L of PO₄³⁻ and 1.2 mg/L of SS. And, two-stage coagulation performed with 1 mg Al/L of aluminum sulfate and then with 4 mg/L of polyaluminum chloride resulted in 0.19 mg/L of TP, 0.16 mg/L of PO₄³⁻ and 3.2 mg/L of SS.

Accordingly, it can be seen that the coagulation and sedimentation occur the most effectively when the aluminum sulfate and polyaluminum chloride are injected such that the Al content is the same. It is because the low-molecular-weight inorganic coagulant aluminum sulfate improves coagulation of dissolved phosphorus and the high-molecular-weight inorganic coagulant polyaluminum chloride improves sedimentation by increasing the size of flocs.

As described above, it was confirmed that the two-stage coagulation process according to the present disclosure is capable of more effectively removing phosphorus by using the two inorganic coagulants with different properties as compared to the existing one-stage coagulation process. The two-stage coagulation process is also more effective than the one-stage coagulation process in terms of the amount of the coagulant used. This means that the addition amount of the inorganic coagulant may be reduced when the two-stage coagulation process is employed.

While the exemplary embodiments have been shown and described, it will be understood by those skilled in the art that various changes in form and details may be made thereto without departing from the spirit and scope of the present disclosure as defined by the appended claims.

What is claimed is:

1. An apparatus for removing phosphorous from wastewater comprising:
a first coagulation sedimentation unit comprising a first rapid mixing tank, a first flocculation tank and a first sedimentation tank; and
a second coagulation sedimentation unit comprising a second rapid mixing tank, a second flocculation tank and a second sedimentation tank,
wherein
the first rapid mixing tank stirs wastewater and an inorganic coagulant with low basicity at high speed so as to generate flocs by reacting phosphide anions included in the wastewater directly with metal cations included in the inorganic coagulant with low basicity, and
the second rapid mixing tank stirs the treated water supplied from the first sedimentation tank and an inorganic coagulant with high basicity at high speed so as to generate hydroxide salts by reacting the flocs included in the treated water with the inorganic coagulant with high basicity,
the inorganic coagulant with low basicity having a relatively lower basicity than that of the inorganic coagulant added to the second rapid mixing tank, and the inorganic coagulant with high basicity having a relatively higher basicity than that of the inorganic coagulant added to the first rapid mixing tank.

2. The apparatus for removing phosphorous from wastewater according to claim 1, wherein the inorganic coagulant with low basicity and the inorganic coagulant with high basicity are respectively added to the first rapid mixing tank and the second rapid mixing tank such that the metal content of the inorganic coagulant with low basicity is the same as the metal content of the inorganic coagulant with high basicity.

3. The apparatus for removing phosphorous from wastewater according to claim 1, wherein aluminum sulfate and polyaluminum chloride are used respectively as the inorganic coagulant with low basicity and the inorganic coagulant with high basicity such that the aluminum (Al) content of the two is identical.

4. The apparatus for removing phosphorous from wastewater according to claim 1, wherein the amount of the inorganic coagulants added respectively to the first rapid mixing tank and the second rapid mixing tank is 0.1-15 wt % based on the total phosphorus (TP) included in the wastewater in the respective rapid mixing tanks.

5. The apparatus for removing phosphorous from wastewater according to claim 1, wherein the inorganic coagulant with low basicity is one of aluminum sulfate, ferric sulfate, aluminum chloride, ferric chloride, ferric aluminum sulfate and magnesium chloride.

6. The apparatus for removing phosphorous from wastewater according to claim 1, wherein the inorganic coagulant with high basicity is one of polyaluminum chloride, polyaluminum chloride silicate, polyaluminum hydroxychlorosulfate, polyaluminum chloride sulfate silicate and polyaluminum sulfate silicate.

7. A method for removing phosphorous using an apparatus comprising a first coagulation sedimentation unit comprising a first rapid mixing tank, a first flocculation tank and a first sedimentation tank and a second coagulation sedimentation unit comprising a second rapid mixing tank, a second flocculation tank and a second sedimentation tank, comprising:
the first rapid mixing tank stirring wastewater and an inorganic coagulant with low basicity at high speed so as to generate flocs by reacting phosphide anions included in the wastewater directly with metal cations included in the inorganic coagulant with low basicity; and
the second rapid mixing tank stirring the treated water supplied from the first sedimentation tank and an inorganic coagulant with high basicity at high speed so as to generate hydroxide salts by reacting the flocs included in the treated water with the inorganic coagulant with high basicity,
wherein the inorganic coagulant with low basicity has a relatively lower basicity than that of the inorganic coagulant added to the second rapid mixing tank, and the inorganic coagulant with high basicity has a relatively higher basicity than that of the inorganic coagulant added to the first rapid mixing tank.

8. The method for removing phosphorous from waste water according to claim 7, wherein the inorganic coagulant with low basicity and the inorganic coagulant with high basicity are respectively added to the first rapid mixing tank and the second rapid mixing tank such that the metal content of the inorganic coagulant with low basicity is the same as the metal content of the inorganic coagulant with high basicity.

9. The method for removing phosphorous from waste water according to claim 7, wherein aluminum sulfate and polyaluminum chloride are used respectively as the inorganic coagulant with low basicity and the inorganic coagulant with high basicity such that the aluminum (Al) content of the two is identical.

10. The method for removing phosphorous from waste water according to claim 7, wherein the amount of the inorganic coagulants added respectively to the first rapid mixing tank and the second rapid mixing tank is 0.1-15 wt % based on the total phosphorus (TP) included in the wastewater in the respective rapid mixing tanks.

11. The method for removing phosphorous from waste water according to claim 7, wherein the inorganic coagulant with low basicity is one of aluminum sulfate, ferric sulfate, aluminum chloride, ferric chloride, ferric aluminum sulfate and magnesium chloride and the inorganic coagulant with high basicity is one of polyaluminum chloride, polyaluminum chloride silicate, polyaluminum hydroxychlorosulfate, polyaluminum chloride sulfate silicate and polyaluminum sulfate silicate.
